(19) United States
(12) Patent Application Publication
(10) Pub. No.: US 2011/0169208 A1
(43) Pub. Date: Jul. 14, 2011

(54) Cutting board

(76) Inventors: Juan-Ramon Almeda, Elizabeth, NJ (US); Estella Maris-Martinez, Elizabeth, NJ (US)

(21) Appl. No.: 12/655,813

(22) Filed: Jan. 8, 2010

(51) Int. Cl. B23Q 3/00

(52) U.S. Cl. 269/289 R

(57) ABSTRACT

A cutting board is of rectangular shape and comprises: a front surface; a rear surface; a right lateral surface; a left lateral surface; an extended opening or slot; a circular opening; a top surface; and a bottom surface. The circular opening is located near the front surface; and the extended opening or slot is located near the rear surface.

### BACKGROUND OF THE INVENTION

1. Field of the Invention

This invention generally relates to a Cutting Board and in particular to a cutting board which may be utilized for processing fish, meat, vegetables or other items.

2. Description of the Prior Art

The prior art reveals the following references: Primavera et al Patent Application Publication #2007/0036886 discloses: “A system for peeling fruits and vegetables, comprising: (a) an inclined board having an upper surface comprising a plurality of parallel ridges laterally disposed thereon adapted to hold a fruit or vegetable thereon and a downwardly extending support member adapted to support said board in an inclined position when said board is placed on a surface; and (b) a hand tool having an upper end adapted for being held by hand and a lower end downwardly inclined from the upper end and with a lower edge adapted to peel a fruit or vegetable placed on said board.”

Quinney et al Patent Application Publication # 2007/0026785 discloses: “A portable working surface apparatus for support along a surface of a vertical support structure, the portable working surface apparatus comprising a work surface board with a work surface and an upright stanchion operatively connected with the work surface board and extending away from the work surface to provide a connection point spaced from the work surface, the stanchion further including a lower engagement member for engaging the surface of the vertical support structure at a position below the connection point.”

Goldberg et al Patent Application Publication # 2006/0254472 discloses: “A work surface device, comprising: a rectangular upper member including four corners and an opening therein for disposing of waste on the work surface device through the opening and into an underlying container; a rectangular work board removably place-able with respect to the upper member, the rectangular work board including a shape and dimensions generally matching the shape and dimensions of the upper member, the work board having an opening positioned for alignment with the opening of the upper member when the work board is placed on the top surface; four respective legs extending downward from the four corners of the upper member for supporting the upper member a spaced vertical distance above a flat support member in a generally horizontal orientation, the four respective legs including a length sufficient to allow the container to be supported on the flat support member underneath the opening of the upper member so that waste on the work surface device is disposed through the opening and into the underlying container supported on the flat support member.”

Sampson et al Patent Application Publication # 2006/0240757 discloses: “A bait cutting table for use with an adjustable drink holder for fishing boats comprising of; a flat cutting board surface perpendicular to a cylindrical portion that fits securely into the open cup portion of an adjustable drink holder for fishing boats.”

Sorey Patent Application Publication # 2006/0240758 discloses: “A fishing aid station that provides a source of running water for cutting bait and cleaning fish while providing a source of chum for attracting fish, said fishing aid station comprising: a frame having four sidewalls and a bottom that define an area in which bait or fish may be deposited for processing; a water pumping source attached to said frame that provides running water to be passed across said frame; a pair of support arms adjustably attached to said frame; and, a clamping mechanism attached to each of said support arms that quickly couples and de-couples the fishing aid station to a fishing structure.”

Jeska Patent Application Publication # 2006/0101959 discloses: “A cutting board apparatus, comprising: opposing surfaces, including a first surface and a second surface, wherein the first surface includes a substantially planar portion and the second surface includes a recessed portion defined by the second surface and positioned within a central portion of the second surface; and at least one handle comprising a first portion secured to and projecting away from the apparatus and a second portion transverse to the first portion.”

Mosko Patent Application Publication # 2005/0241984 discloses: “A marine knife block for mounting on a support structure to hold knives safely and securely, comprising: three substantially rectangular uniform layers of plastic resin attached together face-to-face in a sandwiched configuration, at least one of said plastic layers having a plurality of channels extending from top to near bottom along a face thereof which form blade receptacles when sandwiched against another of said rectangular layers, said three layers each having a plurality of aligned securement holes formed there through and a plurality of screws through said securement holes for securing the three rectangular layers of plastic together in said sandwiched configuration.”

Johnson et al Patent Application Publication # 2004/0207140 discloses: “A cutting board for food items, the cutting board comprising: a body having a top side, a bottom side, and a lattice portion; the lattice portion having an area with an upwardly facing cutting surface and a multiplicity of apertures extending from the upwardly facing cutting surface through the body, the apertures having greater than 50% of the area of the lattice portion, the lattice portion further comprising a plurality of gripping portions positioned at each aperture for securing the food items to be cut upon the cutting board.”

Leili et al Patent Application Publication # 2004/0147212 discloses: “A portable “Leg-Less” apparatus for cleaning fish, wherein said apparatus is removably attached to any piling or other vertical column having a diameter greater than 2 inches, said apparatus comprising: (a) a rectangular frame cutting board of wood or moldable plastics having two Vertical Support Arms and two Side Support Boards and two Rear Support Boards for strength; (b) a nylon rope attaching to the Pole Mounting Hinge Supports, said rope being sufficient in size to allow the station to be tied to vertical supports in excess of 18 inches in diameter; (c) a plurality of stainless steel hinges that attach to the Pole Mounting Hinge Supports to allow the station to rotate up for cleaning off waste material and to fold flat for convenient storage; (d) mounting cleat aligned and attached to either side of the Pole Mounting Hinge Supports arms to allow the previous rope to be fastened securely; (e) handle ⅝ inch in diameter that extends between the Pole Mounting Hinge Support arms at the bottom, to form a carrying handle, said handle is covered with PVC. ¾ inch; (f) support plate connected to each Pole Mounting Hinge Support, said support plate which selectively holds said support arms in place for mounting. (g) the use of stainless steel screws, nuts and bolts for assembly. (h) a semi-circle cutout on the cutting board to allow for fish waste to be scraped into the water, or into a bucket which can be attached to the handle below the board.”

Thompson et al Patent Application Publication # 2004/0046301 discloses: “A modular cutting board primarily for use in sites outside a kitchen environment, comprising: at least two plates made of a non absorbent material; said plates being integrally connected such that said plates may be rotated between an open position in which a flat planar working surface is presented to the user, and a closed transport and storage position wherein said plates are in face to face relation.”

Benjamin Patent Application Publication # 2002/0195763 discloses: “A cutting board assembly comprising: a cutting board comprising an aperture with a first shape; and a colored indicator having a second shape in conformity with the first shape, the colored indicator being disposed at least in part within the aperture.”

Simonson Patent Application Publication # 2002/0096092 discloses: “A portable work stand comprising: a. a table having a frame, and a cross-tray, the cross tray located within the frame and attached thereto, the cross tray further having a pair of leg retaining slots defined in the bottom of the cross tray; b. a plurality of legs, having ends adapted for rotatable attachment to the table, such that when the legs are folded adjacent the table the legs will selectively mate with the leg retaining slot and retain the legs in a folded position; and c. a cutting board adapted for selective attachment to the table.”

A review of the aforementioned prior art references will reveal that the Cutting Board of the present invention is not disclosed in such references.

An object of the present invention is to provide a Cutting Board that is simple to manufacture and that can be made from commonly available and inexpensive materials.

### SUMMARY OF THE INVENTION

According to the present invention, a cutting board is of rectangular shape and comprises: a front surface; a rear surface; a right lateral surface; a left lateral surface; an extended opening or slot; a circular opening; a top surface; and a bottom surface. The circular opening is located near the front surface; and the extended opening or slot is located near the rear surface. A feature and advantage of the present invention is that it has a unitary structure that is easy to manufacture.

### BRIEF DESCRIPTION OF THE DRAWINGS

The above and other features, objects, and advantages of the present invention will be further appreciated from a reading of the following detailed description in conjunction with the drawing in which:

FIG. 1 is a top plan view of the Cutting Board according to the present invention.

FIG. 2 is a bottom plan view of the Cutting Board according to the present invention.

FIG. 3 is a front elevational view of the Cutting Board according to the present invention.

FIG. 4 is a rear elevational view of the Cutting Board according to the present invention.

FIG. 5 is a left side elevational view of the Cutting Board according to the present invention.

FIG. 6 is a right side elevational view of the Cutting Board according to the present invention.

FIG. 7 is an isometric view of the Cutting Board according to the present invention.

### DETAILED DESCRIPTION OF THE INVENTION

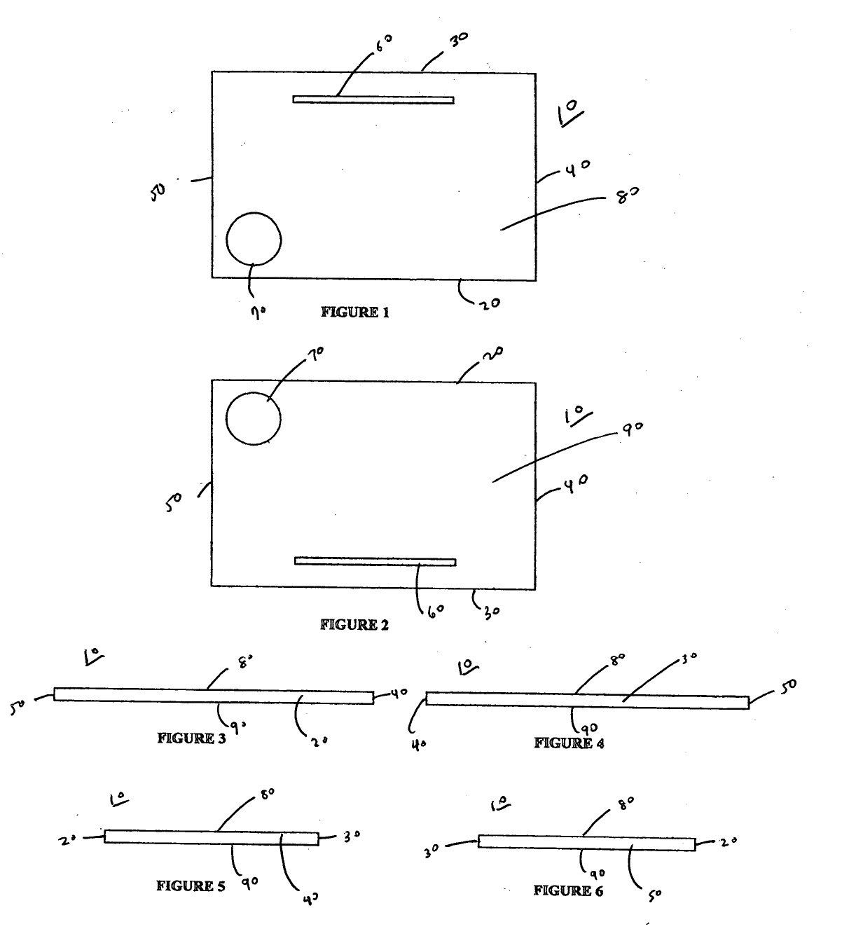

FIG. 1 is a top plan view of the Cutting Board according to the present invention. FIG. 1 shows Cutting Board 10 comprising: front surface 20; rear surface 30; right lateral surface 40; left lateral surface 50; rear extended opening or slot 60; front left lateral circular opening 70; and top surface 80.

FIG. 2 is a bottom plan view of the Cutting Board according to the present invention. FIG. 2 shows Cutting Board 10 comprising: front surface 20; rear surface 30; right lateral surface 40; left lateral surface 50; rear extended opening or slot 60; front left lateral circular opening 70; and bottom surface 90.

FIG. 3 is a front elevational view of the Cutting Board according to the present invention. FIG. 3 shows Cutting Board 10 comprising: front surface 20; right lateral surface 40; left lateral surface 50; rear extended opening or slot 60; front left lateral circular opening 70; top surface 80; and bottom surface 90.

FIG. 4 is a rear elevational view of the Cutting Board according to the present invention. FIG. 4 shows Cutting Board 10 comprising: rear surface 30; right lateral surface 40; left lateral surface 50; top surface 80; and bottom surface 90.

FIG. 5 is a left side elevational view of the Cutting Board according to the present invention. FIG. 5 shows Cutting Board 10 comprising: front surface 20; rear surface 30; right lateral surface 40; top surface 80; and bottom surface 90.

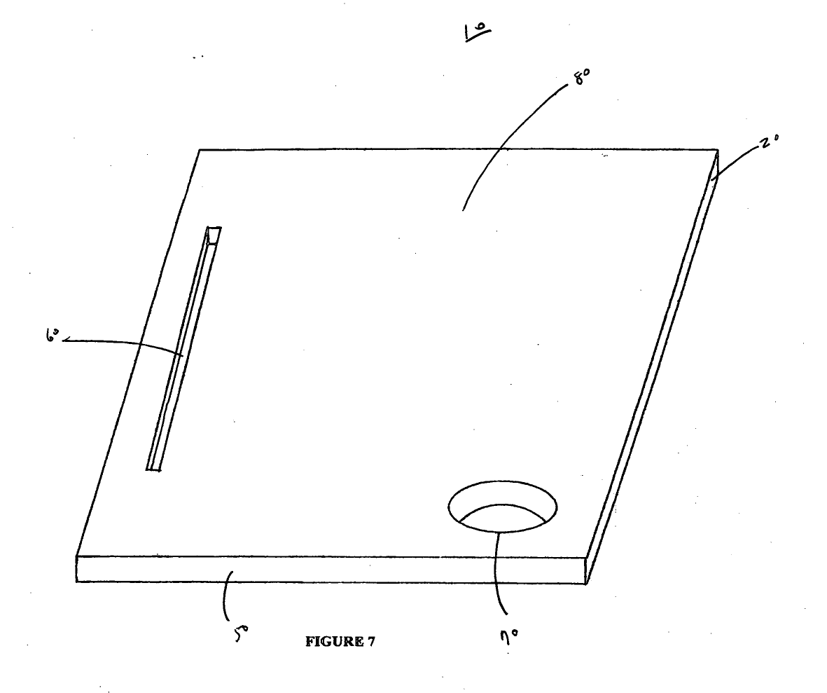

FIG. 6 is a right side elevational view of the Cutting Board according to the present invention. FIG. 6 shows Cutting Board 10 comprising: front surface 20; rear surface 30; left lateral surface 50; top surface 80; and bottom surface 90.

FIG. 7 is an isometric view of the Cutting Board according to the present invention. FIG. 7 shows Cutting Board 10 comprising: front surface 20; left lateral surface 50; rear extended opening or slot 60; front left lateral circular opening 70; and top surface 80.

Cutting Board 10 may advantageously be made of wood or any other desirable material. Cutting Board 10 may advantageously be rectangular as shown, square or any other desirable shape. Cutting board 10 may have a length of 12 units and a width of 8 units such as 12 inches by 8 inches. Cutting board 10 may have a thickness of 1/24 unit. Extended opening or slot 60 may have a length of 6 units and a width of 1/48 unit. Circular opening 70 may have a diameter of 2 units such as 2 inches. Cutting board 10 may be supported along left lateral surface 50 by an upright pole and struts or other suitable means.

What is claimed is:

1. A cutting board being of rectangular shape and comprising: a front surface; a rear surface; a right lateral surface; a left lateral surface; an extended opening or slot; a circular opening; a top surface; and a bottom surface.

2. In the cutting board of claim 1, wherein said circular opening is located near said front surface; and said extended opening or slot is located near said rear surface.

3. In the cutting board of claim 1, said front and rear surfaces being about 12 units long; and said right lateral and left lateral surfaces being about 8 units long.

4. In the cutting board of claim 1, said front and rear surfaces being about 12 units long; said right lateral and left lateral surfaces being about 8 units long; and the diameter of said circular opening being about 2 units.

5. In the cutting board of claim 1, said front and rear surfaces being about 12 units long; said right lateral and left lateral surfaces being about 8 units long; and said extended opening or slot having a length of about 6 units and a width of about 1/48 unit.
